(19) United States
(12) Patent Application Publication
(10) Pub. No.: US 2013/0253853 A1
(43) Pub. Date: Sep. 26, 2013

(54) STRESS FACTOR DRIVEN MAINTENANCE AND SCHEDULING

(71) Applicants: William Joseph Wunderlin, Greenville, SC (US); Gerald Addison Curtin, Niskayuna, NY (US); Dale Ray Cleaveland, SR., Easley, SC (US); John David Hilton, JR., East Greenbush, NY (US); James William Sneed, Greenville, SC (US)

(72) Inventors: William Joseph Wunderlin, Greenville, SC (US); Gerald Addison Curtin, Niskayuna, NY (US); Dale Ray Cleaveland, SR., Easley, SC (US); John David Hilton, JR., East Greenbush, NY (US); James William Sneed, Greenville, SC (US)

(73) Assignee: General Electric Company

(21) Appl. No.: 13/426,741

(22) Filed: Mar. 22, 2012

(51) Int. Cl. G06F 19/00

(52) U.S. Cl. 702/42

(57) ABSTRACT

In one aspect, embodiments of a method of using one or more stress factors to determine whether or when to perform a maintenance activity are described. One embodiment of the method comprises identifying one or more maintenance activities for a system; associating one or more stress factors to each of the identified one or more maintenance activities for the system; determining a value for each of the one or more associated one or more stress factors; and determining, using a computing device, whether to schedule one of the one or more maintenance activities for the system based on the determined value of each of the one or more stress factors associated with the one of the one or more maintenance activities.

### FIELD OF THE INVENTION

Embodiments of the present invention are directed to a methods, systems and computer program products for determining maintenance activities of a system and scheduling of such maintenance based on one or more stress factors where values for the stress factors can be determined based on monitoring or predicted based on operational parameters of the system.

### BACKGROUND OF THE INVENTION

In recent years, reliance upon wind as a source of energy has grown. As reliance upon wind as a source of energy continues to grows, increased efficiency and availability of wind turbines and wind turbine farms increases in importance.

Generally, a wind turbine converts wind energy into rotational energy, and more specifically, converts kinetic energy of wind into mechanical energy. The mechanical energy is used for producing electrical power. Wind turbines may include a rotor having multiple blades that rotate in response to force provided by the wind. Upon rotating the multiple blades, a drive shaft rotates, which in turn drives an electrical generator to generate the electrical power.

A wind farm or wind park (these two phrases will be used interchangeably herein) is a group of interconnected wind turbines at a location. A wind farm may be comprised of one wind turbine, two wind turbines and up to hundreds of wind turbines. The boundaries of the wind farm may cover a small area of hundreds of square yards (square meters) to an extended area of hundreds of square miles (square kilometers). The location of the wind farm may be inland, off-shore, or near-shore, and typically selected to maximize the electrical energy generated by the wind.

Wind turbines and wind farms can be monitored by a computer system, for example, a Supervisory Control and Data Acquisition system (“SCADA” system). The SCADA system can monitor and control a plant or equipment in industries such as telecommunications, water and waste control, energy, oil and gas refining, transportation. The SCADA system can gather information, such as whether a wind turbine has tripped off-line, transfer the information back to a central site, alert a home station that the trip has occurred, carry out necessary analysis and control, such as determining whether the cause of the trip is critical, and display information in a logical and organized manner. The SCADA system can be simple, such as a system that monitors environmental conditions of a small office building, or complex, such as a system that monitors all activity in a nuclear power plant, a municipal water system or multiple wind farms.

As wind turbines and wind farms become more integrated into the electrical grid and become a larger percentage of generated power base, maintenance and availability of the wind turbine generators becomes increasingly important. Therefore, determining whether maintenance is required or when it is required can help increase availability of wind turbines and reduce maintenance costs.

Therefore, what are desired are methods, systems and computer program products that overcome challenges in the art, some of which are described above.

### BRIEF DESCRIPTION OF THE INVENTION

Described herein are embodiments of methods, systems or computer program to use stress factors associated with maintenance items to determine whether and when to perform certain maintenance items.

In one aspect, embodiments of a method of using one or more stress factors to determine whether or when to perform a maintenance activity are described. One embodiment of the method comprises identifying one or more maintenance activities for a system; associating one or more stress factors to each of the identified one or more maintenance activities for the system; determining a value for each of the one or more associated stress factors; and determining, using a computing device, whether to schedule one of the one or more maintenance activities for the system based on the determined value of each of the one or more stress factors associated with the one of the one or more maintenance activities.

In another aspect, embodiments of systems of using one or more stress factors to determine whether or when to perform a maintenance activity are described. One embodiment comprises a network interface; a memory; and a processor, wherein the processor is operably connected to the memory and the network interface, and the processor is configured to: store, in the memory, one or more maintenance activities that have been identified for a mechanical system; associate one or more stress factors to each of the identified one or more maintenance activities for the mechanical system and store the associated stress factors in the memory; receive information related to at least one of the one or more associated stress factors and determine a value for each of the one or more associated stress factors based at least in part on the received information, wherein at least part of the received information can be received over a network via the network interface; and determine whether to schedule one of the one or more maintenance activities for the mechanical system based on the determined value of each of the one or more stress factors associated with the one of the one or more maintenance activities.

In yet another aspect, embodiments of a computer program product of using one or more stress factors to determine whether or when to perform a maintenance activity are described. One embodiment comprises computer-executable code sections stored on a non-transitory computer readable medium. The computer-executable code sections comprise a first section for associating one or more stress factors to each of one or more maintenance activities for a system; a second code section for determining a value for each of the one or more associated stress factors; and a third code section for determining whether to schedule one of the one or more maintenance activities for the system based on the determined value of each of the one or more stress factors associated with the one of the one or more maintenance activities.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods, systems and computer program products:

FIG. 1 is a perspective view of an exemplary embodiment of a wind turbine in accordance with the present disclosure;

FIG. 2 is a partially cut-away perspective view of a portion of the wind turbine shown in FIG. 1 in accordance with the present disclosure;

FIG. 3 is a schematic diagram of a wind turbine in accordance with the present disclosure;

FIG. 4 is an overview block diagram of an embodiment of a wind farm system as described herein;

FIG. 5 is a flowchart that illustrates an embodiment of a method of using stress factors associated with maintenance items to determine whether and when to perform the maintenance items on a system;

FIG. 6 is a non-limiting graphical example illustrating the trigger point, accumulated stress, and forecast stress for a maintenance activity; and

FIG. 7 is a block diagram illustrating an exemplary operating environment for performing the disclosed methods.

Wherever possible, the same reference numbers will be used throughout the drawings to represent the same parts.

### DETAILED DESCRIPTION OF THE INVENTION

Before the present methods, systems and computer program products are disclosed and described, it is to be understood that the methods, systems and computer program products are not limited to specific synthetic methods, specific components, or to particular compositions. It is also to be understood that the terminology used herein is for describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods, systems and computer program products. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the Examples included therein and to the Figures and their previous and following description.

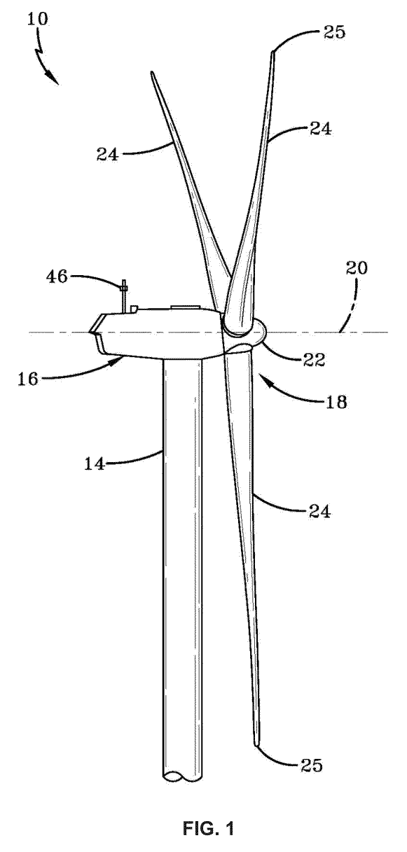

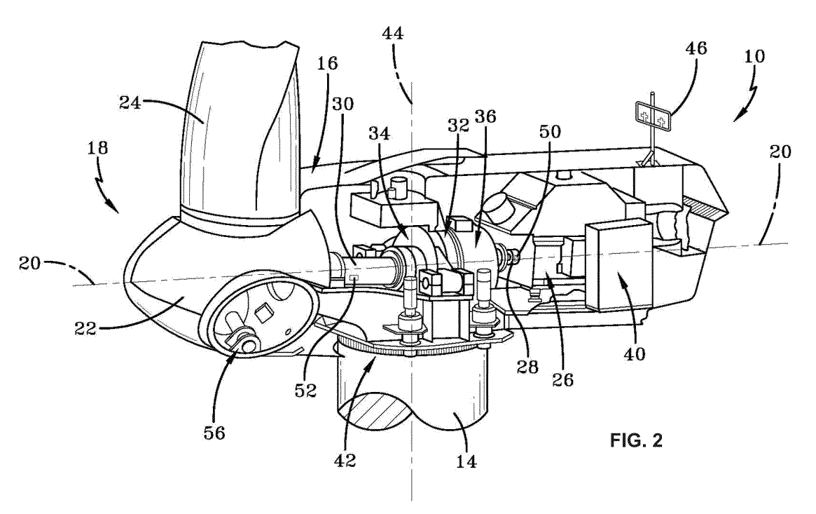

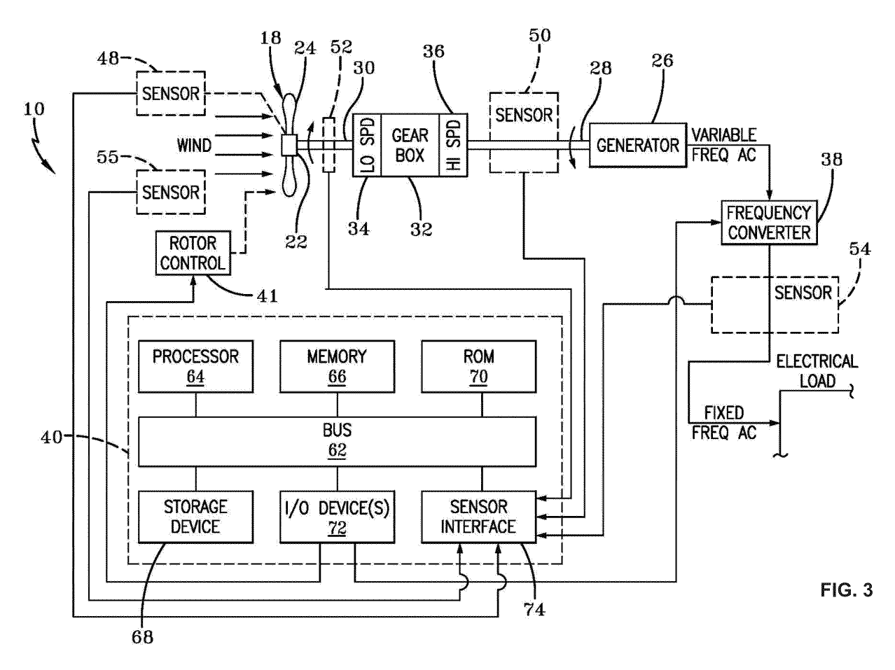

FIG. 1 is a perspective view of an exemplary wind turbine generator 10 in accordance with an embodiment of the present disclosure. FIG. 2 is a partially cut-away perspective view of a portion of an exemplary wind turbine generator 10 in accordance with an embodiment of the present disclosure. FIG. 3 is a schematic diagram of an exemplary wind turbine 10. According to embodiments of the present disclosure, maintenance activities for a system such as a wind turbine generator can be identified. These maintenance activities can be associated with one or more stress factors. Values can be determined for each of the one or more associated stress factors. Maintenance activities for the system can be scheduled based on the determined value of each of the one or more stress factors associated with the one of the one or more maintenance activities.

The exemplary wind turbine 10 (herein, wind turbine and wind turbine generator shall be used interchangeably) described and illustrated herein is a wind generator for generating electrical power from wind energy. However, in some embodiments, wind turbine 10 may be, in addition or alternative to a wind generator, any type of wind turbine, such as, but not limited to, a windmill (not shown). Moreover, the exemplary wind turbine 10 described and illustrated herein includes a horizontal-axis configuration. However, in some embodiments, wind turbine 10 may include, in addition or alternative to the horizontal-axis configuration, a vertical-axis configuration (not shown). Wind turbine 10 may be coupled to an electrical load (not shown), such as, but not limited to, a power grid (not shown) for receiving electrical power therefrom to drive operation of wind turbine 10 and/or its associated components and/or for supplying electrical power generated by wind turbine 10 thereto. Although only one wind turbine 10 is shown in FIGS. 1-3, in some embodiments a plurality of wind turbines 10 may be grouped together, sometimes referred to as a “wind farm” or “wind park.”

The exemplary wind turbine 10 includes a body 16, sometimes referred to as a “nacelle”, and a rotor (generally designated by 18) coupled to body 16 for rotation with respect to body 16 about an axis of rotation 20. In the exemplary embodiment, nacelle 16 is mounted on a tower 14. The height of tower 14 may be any suitable height enabling wind turbine 10 to function as described herein. Rotor 18 includes a hub 22 and a plurality of blades 24 (sometimes referred to as “airfoils”) extending radially outward from hub 22 for converting wind energy into rotational energy. Each blade 24 has a tip 25 positioned at the end thereof, which is distant from the hub 22. Although rotor 18 is described and illustrated herein as having three blades 24, rotor 18 may have any number of blades 24. Blades 24 may each have any length (whether or not described herein).

Despite how rotor blades 24 are illustrated in FIG. 1, rotor 18 may have blades 24 of any shape, and may have blades 24 of any type and/or any configuration, whether or not such shape, type, and/or configuration is described and/or illustrated herein. Another example of a type, shape, and/or configuration of rotor blades 24 is a Darrieus wind turbine, sometimes referred to as an “eggbeater” turbine. Yet another example of a type, shape, and/or configuration of rotor blades 24 is a Savonious wind turbine. Even another example of another type, shape, and/or configuration of rotor blades 24 is a traditional windmill for pumping water, such as, but not limited to, four-bladed rotors having wooden shutters and/or fabric sails. Moreover, the exemplary wind turbine 10 may, in some embodiments, be a wind turbine wherein rotor 18 generally faces upwind to harness wind energy, and/or may be a wind turbine wherein rotor 18 generally faces downwind to harness energy. Of course, in any embodiments, rotor 18 may not face exactly upwind and/or downwind, but may face generally at any angle (which may be variable) with respect to a direction of the wind to harness energy therefrom.

Referring now to FIGS. 2 and 3, the exemplary wind turbine 10 includes an electrical generator 26 coupled to rotor 18 for generating electrical power from the rotational energy generated by rotor 18. Generator 26 may be any suitable type of electrical generator, such as, but not limited to, a wound rotor induction generator. Generator 26 includes a stator (not shown) and a rotor (not shown). Wind turbine rotor 18 includes a rotor shaft 30 coupled to rotor hub 22 for rotation therewith. Generator 26 is coupled to rotor shaft 30 such that rotation of rotor shaft 30 drives rotation of the generator rotor, and therefore operation of generator 26. In the exemplary embodiment, the generator rotor has a rotor shaft 28 coupled thereto and coupled to rotor shaft 30 such that rotation of rotor shaft 30 drives rotation of the generator rotor. In other embodiments, the generator rotor is directly coupled to rotor shaft 30, sometimes referred to as a “direct-drive wind turbine.” In the exemplary embodiment, generator rotor shaft 28 is coupled to rotor shaft 28 through a gearbox 32, although in other embodiments the generator rotor shaft 28 is coupled directly to rotor shaft 30. More specifically, in the exemplary embodiment, gearbox 32 has a low speed side 34 coupled to rotor shaft 30 and a high speed side 36 coupled to generator rotor shaft 28. The torque of rotor 18 drives the generator rotor to thereby generate variable frequency AC electrical power from rotation of rotor 18. Generator 26 has an air gap torque between the generator rotor and stator that opposes the torque of rotor 18. A frequency converter 38 is coupled to generator 26 for converting the variable frequency AC to a fixed frequency AC for delivery to an electrical load (not shown), such as, but not limited to, a power grid (not shown), coupled to generator 26. Frequency converter 38 may be located anywhere within or remote to wind turbine 10. For example, in the exemplary embodiment, frequency converter 38 is located within a base (not shown) of tower 14.

In one aspect. exemplary wind turbine 10 includes one or more control systems embodied in a turbine control unit (TCU) 40 coupled to some or all of the components of wind turbine 10 for generally controlling operation of wind turbine 10 and/or some or all of the components thereof (whether or not such components are described and/or illustrated herein). In one aspect. the TCU 40 may be used for, but is not limited to, power generation monitoring and control including, for example, pitch and speed regulation, high-speed shaft and yaw brake application, yaw and pump motor application, and/or fault monitoring. Alternative distributed or centralized control architectures may be used in some embodiments.

In some embodiments, wind turbine 10 may include a disc brake (not shown) for braking rotation of rotor 18 to, for example, slow rotation of rotor 18, brake rotor 18 against full wind torque, and/or reduce the generation of electrical power from electrical generator 26. Furthermore, in some embodiments, wind turbine 10 may include a yaw system 42 for rotating nacelle 16 about an axis of rotation 44, for changing a yaw of rotor 18, and more specifically for changing a direction faced by rotor 18 to, for example, adjust an angle between the direction faced by rotor 18 and a direction of wind. In one aspect, the yaw system 42 may be coupled to the TCU 40 for control thereby. In some embodiments, wind turbine 10 may include anemometry 46 for measuring wind speed and/or wind direction. Anemometry 46, in some embodiments, may be coupled to the TCU 40 for sending measurements to control system(s) for processing thereof. For example, although anemometry 46 may be coupled to the TCU 40 for sending measurements thereto for controlling other operations of wind turbine 10, anemometry 46 may send measurements to the TCU 40 for controlling and/or changing a yaw of rotor 18 using yaw system 42. Alternatively, anemometry 46 may be coupled directly to yaw system 42 for controlling and/or changing a yaw of rotor 18.

In one aspect, the exemplary wind turbine 10 may also include a plurality of sensors 48, 50, 52, 54, 55 (FIG. 3), for measuring an angle of each blade 24 with respect to a wind direction and/or with respect to rotor hub 22, for measuring a speed of rotation of rotor shaft 28 and/or a torque of generator rotor shaft 28, for measuring a speed of rotation of generator shaft 28 and/or a torque of rotor shaft 30, for measuring an electrical power output of generator 26, for sending measurements to control system(s) for processing, and for measuring parameters of component(s) such as sensors configured to measure displacements, yaw, pitch, movements, strain, stress, twist, damage, failure, rotor torque, rotor speed, an anomaly in the electrical load, and/or an anomaly of power supplied to any component of wind turbine 10, and the like. Such other sensors may couple to any component of wind turbine 10 and/or the electrical load at any location thereof for measuring any parameter thereof, whether or not such component, location, and/or parameter is described and/or illustrated herein.

Referring again to FIG. 3, in some embodiments, the TCU 40 can include a bus 62 or other communications device to communicate information. One or more processor(s) 64 can be coupled to bus 62 to process information, including information from anemometry 46, sensors 48, 50, 52, 54 and/or 55, and/or other sensor(s). The TCU 40 may also include one or more random access memories (RAM) 66 and/or other storage device(s) 68. RAM(s) 66 and storage device(s) 68 are coupled to bus 62 to store and transfer information and instructions to be executed by processor(s) 64. RAM(s) 66 (and/or also storage device(s) 68, if included) can also be used to store temporary variables or other intermediate information during execution of instructions by processor(s) 64. The TCU 40 may also include one or more read only memories (ROM) 70 and/or other static storage devices coupled to bus 62 to store and provide static (i.e., non-changing) information and instructions to processor(s) 64. Input/output device(s) 72 may include any device known in the art to provide input data to control system(s) and/or to provide outputs, such as, but not limited to, yaw control and/or pitch control outputs. Furthermore, in one aspect the TCU 40 interfaces with a supervisory control and data acquisition (SCADA) system (not shown) through the input/output device 72. The SCADA system can be used to collect and monitor data from the wind turbine 10 as well as to provide control commands to the TCU 40. Instructions may be provided to memory from a storage device, such as, but not limited to, a magnetic disk, a read-only memory (ROM) integrated circuit, CD-ROM, and/or DVD, via a remote connection that is either wired or wireless, providing access to one or more electronically-accessible media, etc. In some embodiments, hard-wired circuitry can be used in place of or in combination with software instructions. Thus, execution of sequences of instructions is not limited to any specific combination of hardware circuitry and software instructions, whether described and/or illustrated herein. In one aspect, the TCU 40 may also include a sensor interface 74 that allows control system(s) 40 to communicate with anemometry 46, sensors 48, 50, 52, 54 and/or 55, and/or other sensor(s). Sensor interface 74 can be or can include, for example, one or more analog-to-digital converters that convert analog signals into digital signals that can be used by processor(s) 64.

As noted above, in one aspect the TCU 40 can operate in conjunction with a supervisory control and data acquisition (SCADA) system to dynamically monitor and control wind turbine(s) 10 or wind farm(s). The SCADA system can include a Human-Machine Interface (HMI), a supervisory (computer) system, Remote Terminal Units (RTUs), and a communication infrastructure. The HMI is an apparatus that presents performance-related information to the operator. By using the HMI, the operator can monitor and/or control operation of wind turbine(s) 10 and/or wind farm(s). In one aspect, the HMI includes a graphical user interface (GUI) that allows the operator to interface with the wind farm in a graphical manner. The supervisory system monitors wind turbine(s) 10 and/or wind farm(s) by gathering and/or acquiring information (in the form of data). Also, the supervisory system controls wind turbine(s) 10 and/or wind farm(s) by transmitting commands to wind turbine(s) 10 and/or wind farm(s). The RTUs receive signals from anemometry 46, sensors 48, 50, 52, 54 and/or 55, and/or other sensor(s), convert the signals into digital data, and transmit the digital data to the supervisory system via the communication infrastructure (for example, optical fibers). In one aspect, the TCU 40 comprises an RTU. In one aspect, in addition to the wind turbines 10, the wind farm comprises one or more substation and meteorological stations, each having separate RTUs.

The SCADA system acts as a “nerve center” for wind turbine(s) 10 and/or wind farm(s). The SCADA system continuously analyzes the performance-related information and transmits signals to the GUI so that the performance-related information can be visually depicted in a dynamic manner. The SCADA system can monitor and/or control wind turbine(s) 10 and wind farm(s), one or more substations (not shown), and one or more meteorological stations (not shown) thus allowing the operator to cohesively monitor and/or control wind turbine(s) 10 at a specific location, a wind farm, or any other suitable grouping of wind turbines 10. The SCADA system stores periodic records throughout a given period of time. The periodic records can be based upon activity at the specific location, the wind farm, or any other suitable grouping of wind turbines 10. The periodic records can be analyzed to provide the operator with performance-related information. The performance-related information can be used for implementing corrective action. The SCADA system implements requirements based upon connection agreements to control reactive power production, to contribute to network voltage or frequency control, or to limit power output in response to instructions from a network operator.

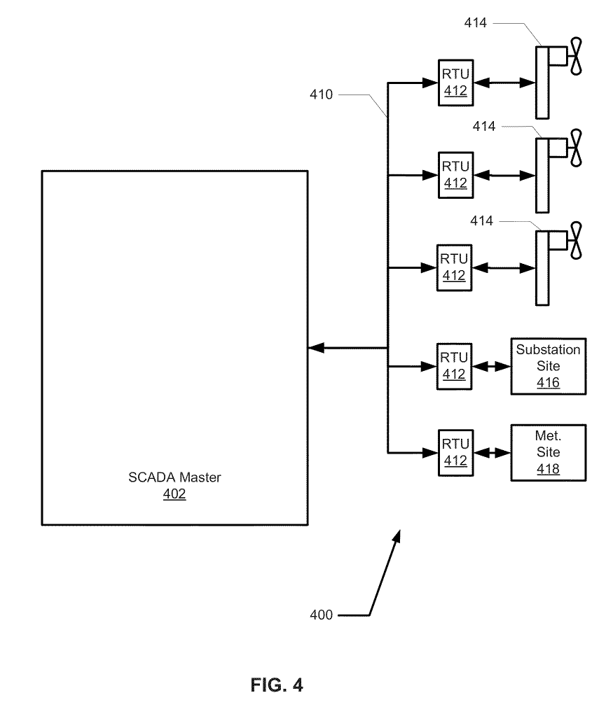

FIG. 4 provides an overview block diagram of an embodiment of a wind farm system as described above. A computing device 402 that can be used as a SCADA-master is described. The SCADA-master 402 communicates over a network 410 with various remote terminal units (RTUs) 412. The network 410 can be wired (including fiber optic or other non-conductive mediums), wireless or a combination thereof as known to one of ordinary skill in the art. In one aspect, the RTUs 412 can comprise turbine control units (TCUs), substation control units (SCUs), meteorological control units (MCUs), and the like. Further comprising the system of FIG. 4 are one or more wind turbines 414, one or more substations 416 and one or more meteorological stations 418.

As shown in FIG. 4, a computing device such as SCADA-master 402 receives supervisory control and data acquisition (SCADA) data for a wind farm 400 over the network 410 or retrieves stored data from a memory. In one aspect, the wind farm 400 is comprised of one or more wind turbines 414. In one aspect, the wind farm 400 is further comprised of one or more meteorological sites 418 and one or more substation sites 416. SCADA data includes parameters for the wind farm including control and operational parameters for the one or more wind turbines 414. In one aspect, the wind farm parameters include historical data and real-time data points. Real-time data points are tags that can be updated into the SCADA system every second from the wind farm (e.g., wind turbines, substation, meteorological controller, output of other rules, etc.). Examples of real-time data points for a wind farm 400 include wind speed, turbine power (turbines), wind direction (meteorological), KVarh import/export (substation), site power (output of aggregation rule), and the like. Historical data can include, for example, current month power production, current year down time, power production till date since commissioning, average generator temperature since last 10 min, average power production since last week, and the like. All of these points, historical and real-time, can be configured using the SCADA-master 402.

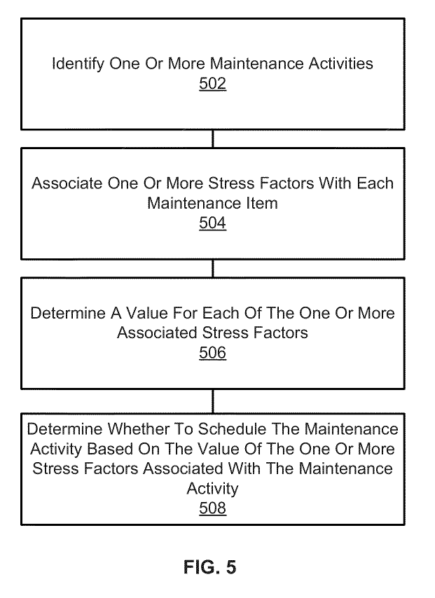

In one aspect, the SCADA master 402 or other computing device can be used to implement a method of using stress factors associated with maintenance items to determine whether and when to perform the maintenance items on a system such as a wind turbine 10, a wind farm 400, or other mechanical system. For example, as shown in the exemplary flow chart of FIG. 5, at step 502 in one aspect one or more maintenance activities for a system can be identified. In one aspect, identifying one or more maintenance activities for the system comprises identifying one or more of lubrication of the system, checking fasteners and re-torque the fasteners if necessary, replacing worn parts, cleaning at least a part of the system, resupplying system consumables, and the like. The maintenance activities once identified can be stored in a database on a memory that is accessible by the SCADA-master 402 or other computing device. In one aspect, the system comprises a wind-turbine generator 10, as described herein. In another aspect, wherein the system comprises a wind-turbine park 400 that is comprised of a plurality of wind-turbine generators and ancillary equipment, as described herein. At step 504, one or more stress factors are associated with each of the identified one or more maintenance activities for the system. In one aspect, associating one or more stress factors to each of the identified one or more maintenance activities for the system comprises associating one or more of calendar time since the last maintenance, age since installation, total energy produced, operating time in each of several operating states, total distance traveled, thermal stress of each component, conditions related to geographic location, humidity, remaining grease, oil condition, turbulence intensity, air quality, wind shear, number of emergency stops, number of starts and stops, component vibrations, blade pitch activity, yaw activity, turbine design, component designs, vendor, manufacturing location, and the like to each of the identified one or more maintenance activities for the system. In one aspect, the stress factors associated with a maintenance activity can be relationally (relational to the maintenance activity) stored in a database on a memory that is accessible by the SCADA-master 402 or other computing device. This can be the same or a different database than the one used to store the maintenance activity. At step 506, a value can be determined for each of the one or more associated stress factors. In one aspect, determining the value for each of the one or more associated stress factors comprises receiving information related to one of the one or more stress factors and updating the value of the one of the one or more stress factors based on the information received. In one aspect, the information can be information about the wind turbine 10 or wind farm 400, as described above. This information can be real-time data or historical data, as described above. In one aspect, at least part of the information is received over a network. In one aspect, the network can comprise the supervisory control and data acquisition (SCADA) network as described herein. In one aspect, determining the value for each of the one or more associated stress factors comprises estimating a future value for each of the one or more associated stress factors using one or more operating parameters of the system and scheduling one of the one or more maintenance activities for the system based at least in part on the estimated future value of each of the one or more stress factors associated with the one of the one or more maintenance activities. For example, in one aspect the system comprises a wind-turbine generator or a wind farm and the one or more operating parameters comprise one or more of historical, present and forecast wind and meteorological measurements, seasonality, climate, air quality, age of wind turbine generator, wind turbulence, power produced by the wind-turbine generator, period of time, information from other wind turbine generators, power factor, trips and faults seen by the wind turbine generator(s), and the like. In one aspect, estimating the future value for each of the one or more associated stress factors comprises estimating the future value for each of the one or more associated stress factors based at least in part on historical values for the one or more stress factors. At step 508, it can be determined, using a computing device such as the SCADA-master 402, whether to schedule one of the one or more maintenance activities for the system based on the determined value of each of the one or more stress factors associated with the one of the one or more maintenance activities. In one aspect, determining whether to schedule one of the one or more maintenance activities for the system based on the determined value of each of the one or more stress factors associated with the one of the one or more maintenance activities further comprises allocating maintenance resources to any scheduled one or more maintenance activities.

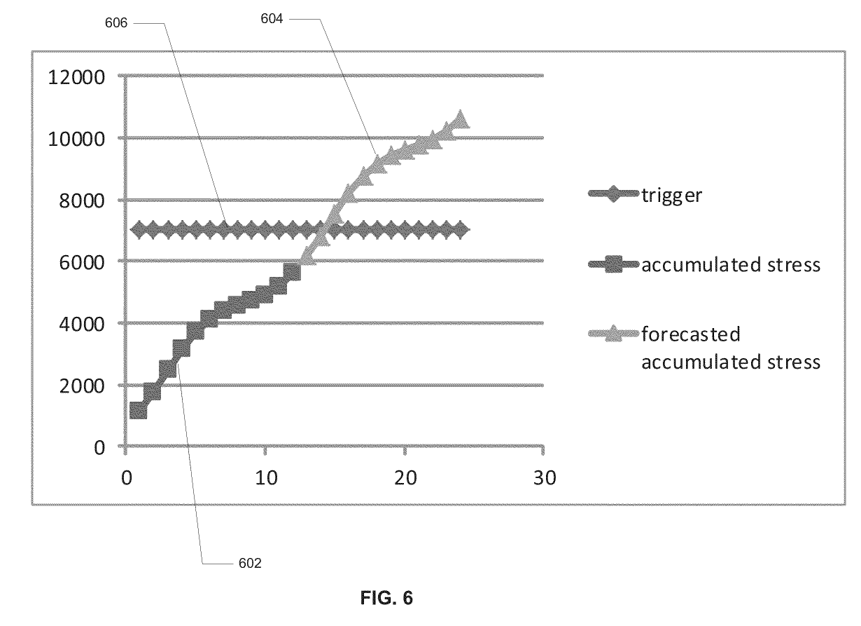

Consider the following example. Each maintenance activity can have an associated “trigger point.” The “trigger point” can be defined as the level of a stress factor or a combination of stress factors where maintenance is required. For example, suppose that yaw brake pads of a wind turbine 10 need to be changed after they travel a total distance of 7000 feet. Then, 7000 feet is the trigger point. Furthermore, in various embodiments stress levels for all critical stress factors can be forecast. The forecast can be based on stress history in past years for this turbine site or similar sites, as well as individual turbine history of stress on the components. The forecasts can be based on historical wind and meteorological measurements. The forecast may include seasonality, since stress levels in the summer are different than stress levels in the winter. The forecasts can be made at the wind park level (applied to all turbines at that park), or at the turbine level (a forecast for each turbine). Using the accumulated information, forecasts can be made for the time that maintenance is required for each activity at each turbine. For each maintenance activity, use the last maintenance time, the cumulative stress since the last maintenance time, a forecast of the stress over time, the transfer function or relation between the stress factors and the maintenance activity, and the critical point (or trigger point) where maintenance is needed to forecast the last date when the maintenance must be performed. In some instances, historical and real time direct observations of a stress response (such as oil condition) can be used in the forecast. As an example, consider the following calculation of the maintenance needed date. Suppose that yaw brake pads need to be changed after they travel a total distance of 7000 feet. They have traveled 5000 feet since the last maintenance. They will need to be replaced after they travel another 7000−5000=2000 feet. If the forecast is 50 feet of travel per day, then the brakes must be replaced in 2000/50=40 days. A non-limiting graphical example illustrating the trigger point, accumulated stress, and forecast stress for a maintenance activity is shown in FIG. 6. In FIG. 6, the time since the last service is shown on the x-axis of the graph and units of stress are represented on the y-axis. For example, the time may be months since the last service on the system under consideration and the stress may be feet of travel of the yaw. Actual, measured stress 602 of the maintenance activity is shown as the square boxes on the graph, forecasted stress 604 is shown as triangles and the trigger point 606 is shown as diamonds. In this example, the trigger 606 is set at approximately 7000 units. In this example, forecast stress 604 is projected to rise above the trigger level in about two months from the last, measured accumulated stress 602, thus requiring the maintenance activity to be scheduled at (or before) the time that the forecast stress 604 intersects the trigger level 606.

Furthering the example, embodiments described herein can be used to schedule maintenance for a turbine, or for an area within a turbine (such as the nacelle). Suppose there will be a schedule for each turbine. Some variables to consider by turbine include, for example: set up time (travel, load, climb), (e.g., two hours/technician); work hours per day (8, 10, etc.), (e.g., a 10 hour work day); technicians on a crew, (e.g., three technicians/crew). Then, the total time the crew will be available is (3*10)=30 hours, and the total time available for maintenance is 30−6=24 hours. For scheduling, the activity with the first required maintenance date for the system (e.g., turbine or wind park) is determined. The next maintenance for the turbine must occur before this date. For efficient use of labor, group several maintenance items together that add up to a certain total maintenance labor time. For example, group together enough work for a crew of three service technicians on one full day. This group of activities will all be performed in one trip to a turbine. Start with the required travel time, climbing time, and set-up time. Add the time required for the first maintenance activity, based on the required date. Continue to add, or pull-in, maintenance activities until you meet the total maintenance labor time, such as 24 hours.

The SCADA-master 402 or other computing device can be configured to “bundle” the tasks, by adding tasks in the order of the need date. It will add tasks until it reaches about one work day for a crew. The computing system can be configured to generate a list of tasks, ordered by the require date. The list can include the time required for the task, special skills, location in the turbine, required tools and required parts. The computing system can create a summary table of the next maintenance need date for each turbine, that can be ordered by turbine and need date. The computing system can keep a list of the available technicians on each date, accounting for things like vacation, holidays, etc. These activities may also be grouped by area of the turbine or types of skills required. For example, all activities performed at the top of the turbine may be grouped together. Or all activities requiring a certain skill set of the technician may be grouped together. At times there are visits to a turbine for unplanned maintenance whereby planned maintenance can be assigned and performed during the same trip. Furthermore, schedules can be determined by turbine area (e.g., hub, nacelle, down tower, tower) as the same variables must be considered for specific areas of the turbine.

Maintenance can also be scheduled for an entire wind park. A wind park typically has a certain staffing level, such as for example six technicians. It is desired to level load their work, so they have about eight hours of work each day, which can reduce labor costs and utilize labor efficiently. Perhaps, for example, the labor forecast shows excess labor available in January, and too much labor required in February. If ten turbines must be maintained in January and 30 are schedule to be maintained in February, then the computing system can be configured to move some of the February maintenance to January. This allows all maintenance to be completed in time, and can reduce overtime. Several wind parks can be combined and treated as one park for scheduling purposes. There are other options for scheduling algorithms, such as integer programs, linear programs, or genetic algorithms, to minimize costs while meeting all constraints. Constraints are required service and labor resources. The following are some variables that can be recorded for each maintenance task in order to more efficiently schedule the maintenance activity: time required for the maintenance task (hours); cumulative stress through the current date; trigger point; forecast of additional stress during each day, for the next few years; the projected date to meet the trigger point, which can be the last day to perform the maintenance task; special technician skill required for each task; parts required; and tools required. Schedules can be generated with different assumptions, such as no overtime, or two hours of overtime per day, etc. The schedules can be configured to highlight when overtime is required, and when there are not enough resources to compete all maintenance.

The SCADA-master or other computing device can be configured to generate reports that show the projected schedule, what is required for the maintenance, and what is moved to an earlier date. This will be used to order materials required for maintenance ahead of time. All past maintenance activities can be maintained by the computing system in a database for use in determining the next required maintenance as well as for storing and displaying all steps in the process, such as the required maintenance item, the schedule for a turbine, the pulled-in schedule for a turbine, and the schedule for a wind park. Furthermore, results from previous weeks can be stored in the database so that changes can be tracked from week to week.

The above system has been described above as comprised of units. One skilled in the art will appreciate that this is a functional description and that software, hardware, or a combination of software and hardware can perform the respective functions. A unit can be software, hardware, or a combination of software and hardware. The units can comprise software 606 as illustrated in FIG. 6 and described below for determining whether to schedule one of the one or more maintenance activities for a system based on the determined value of each of the one or more stress factors associated with the one of the one or more maintenance activities and when to schedule such maintenance. In one exemplary aspect, the units can comprise a computing device such as the SCADA-master 402 as illustrated in FIG. 6 and described below.

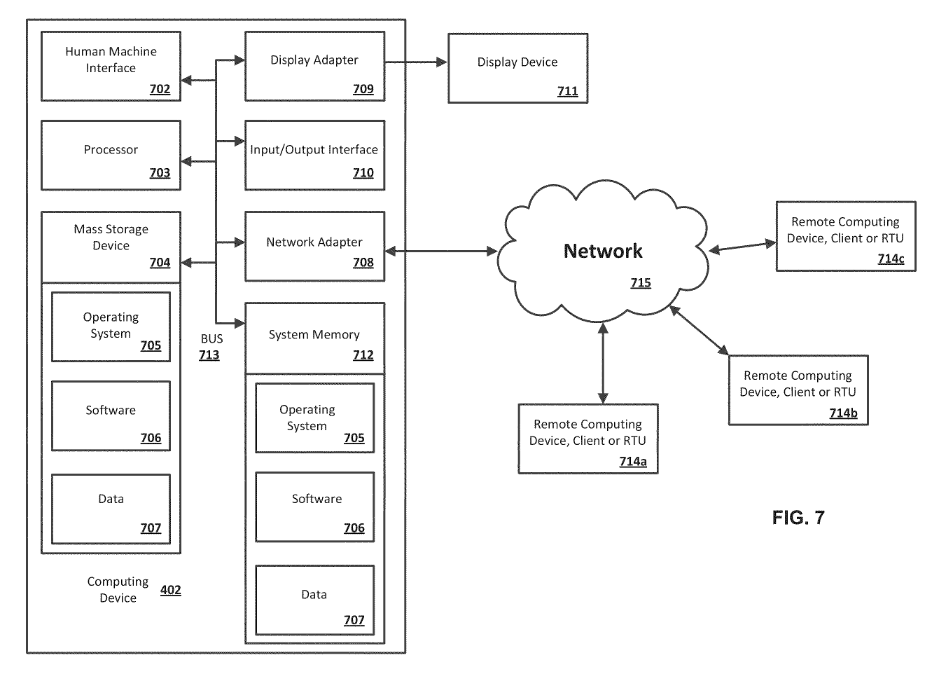

FIG. 7 is a block diagram illustrating an exemplary operating environment for performing embodiments of the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, remote terminal units, smart meters, smart-grid components, distributed computing environments that comprise any of the above systems or devices, programmable logic controllers (PLCs) and the like.

Processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 402. The components of the computing device 402 can comprise, but are not limited to, one or more processors or processing units 703, a system memory 712, and a system bus 713 that couples various system components including the processor 703 to the system memory 712. In the case of multiple processing units 703, the system can utilize parallel computing. In one aspect, the one or more processors or processing units 703 can be configured to associate one or more stress factors to each of one or more identified maintenance activities for a system such as a wind turbine 10 or wind park 400, determine a value for each of the one or more associated stress factors, and determine, using a computing device, whether to schedule one of the one or more maintenance activities for the system based on the determined value of each of the one or more stress factors associated with the one of the one or more maintenance activities. In one aspect, the computing device 402 can receive supervisory control and data acquisition (SCADA) data for a wind turbine 10 or a wind farm comprised of one or more wind turbines, wherein the SCADA data includes parameters for the wind farm, and these parameters used to determine a value for each of the one or more associated stress factors or update the stress factors.

The system bus 713 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 713, and all buses specified in this description can also be implemented over a wired or wireless network connection and each of the subsystems, including the processor 703, a mass storage device 704, an operating system 705, software 706, data 707, a network adapter 708, system memory 712, an Input/Output Interface 710, a display adapter 709, a display device 711, and a human machine interface 702, can be contained within one or more remote computing devices, clients or remote terminal units (RTUs) 714a,b,c at physically separate locations, connected through buses of this form, in effect implementing a fully distributed system or distributed architecture.

The computing device 402 typically comprises a variety of computer readable media. Exemplary readable media can be any available media that is non-transitory and accessible by the computing device 402 and comprises, for example and not meant to be limiting, both volatile and non-volatile media, removable and non-removable media. The system memory 712 comprises computer readable media in the form of volatile memory, such as random access memory (RAM), and/or non-volatile memory, such as read only memory (ROM). The system memory 712 typically contains data such as trigger point data 707 and/or program modules such as operating system 705 and software 706 that are immediately accessible to and/or are presently operated on by the processing unit 703.

In another aspect, the computing device 402 can also comprise other non-transitory, removable/non-removable, volatile/non-volatile computer storage media. By way of example, FIG. 7 illustrates a mass storage device 704 that can provide non-volatile storage of computer code, computer readable instructions, data structures, program modules, and other data for the computing device 402. For example, and not meant to be limiting, a mass storage device 704 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 704, including by way of example, an operating system 705 and software 706. Each of the operating system 705 and software 706 (or some combination thereof) can comprise elements of the programming and the software 706. Data 707 can also be stored on the mass storage device 704. Data 707 can be stored in any of one or more databases known in the art Examples of such databases comprise, DB2® (IBM Corporation, Armonk, N.Y.), Microsoft® Access, Microsoft® SQL Server, (Microsoft Corporation, Bellevue, Wash.), Oracle®, (Oracle Corporation, Redwood Shores, Calif.), mySQL, PostgreSQL, and the like. The databases can be centralized or distributed across multiple systems.

In another aspect, the user can enter commands and information into the computing device 402 via an input device (not shown). Examples of such input devices comprise, but are not limited to, a keyboard, pointing device (e.g., a “mouse”), a microphone, a joystick, a scanner, tactile input devices such as gloves, and other body coverings, and the like. These and other input devices can be connected to the processing unit 703 via a human machine interface 702 that is coupled to the system bus 713, but can be connected by other interface and bus structures, such as a parallel port, game port, an IEEE 1394 Port (also known as a Firewire port), a serial port, a universal serial bus (USB), and the like.

In yet another aspect, a display device 711 can also be connected to the system bus 713 via an interface, such as a display adapter 709. It is contemplated that the computing device 402 can have more than one display adapter 709 and the computing device 402 can have more than one display device 711. For example, a display device can be a monitor, an LCD (Liquid Crystal Display), a projector, and the like. In addition to the display device 711, other output peripheral devices can comprise components such as speakers (not shown) and a printer (not shown), which can be connected to the computing device 402 via Input/Output Interface 710. Any step and/or result of the methods can be output in any form to an output device. Such output can be any form of visual representation, including, but not limited to, textual, graphical, animation, audio, tactile, and the like.

The computing device 402 can operate in a networked environment using logical connections to one or more remote computing devices, clients or RTUs 714a,b,c. By way of example, a remote computing device 714 can be a personal computer, portable computer, a server, a router, a network computer, a smart meter, a vendor or manufacture's computing device, smart grid components, a peer device, an RTU, or other common network node, and so on. Logical connections between the computing device 402 and a remote computing device, client or RTU 714a,b,c can be made via a local area network (LAN) and a general wide area network (WAN). Such network connections can be through a network adapter 708. A network adapter 708 can be implemented in both wired and wireless environments. Such networking environments are conventional and commonplace in offices, enterprise-wide computer networks, intranets, and other networks 715.

For purposes of illustration, application programs and other executable program components such as the operating system 705 are illustrated herein as discrete blocks, although it is recognized that such programs and components reside at various times in different storage components of the computing device 402, and are executed by the data processor(s) of the computer. An implementation of the software 706 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

As described above and as will be appreciated by one skilled in the art, embodiments of the present invention may be configured as a system, method, or computer program product. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable non-transitory computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as the one or more processors 703 discussed above with reference to FIG. 7, to produce a machine, such that the instructions which execute on the computer or other programmable data processing apparatus create a means for implementing the functions specified in the flowchart block or blocks.

These computer program instructions may also be stored in a non-transitory computer-readable memory that can direct a computer or other programmable data processing apparatus (e.g., one or more processors 703 of FIG. 7) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
identifying one or more maintenance activities for a system;
associating one or more stress factors to each of the identified one or more maintenance activities for the system;
determining a value for each of the one or more associated stress factors; and
determining, using a computing device, whether to schedule one of the one or more maintenance activities for the system based on the determined value of each of the one or more stress factors associated with the one of the one or more maintenance activities.

2. The method of claim 1, wherein the system comprises a wind-turbine generator.

3. The method of claim 2, wherein associating one or more stress factors to each of the identified one or more maintenance activities for the system comprises associating one or more of calendar time since the last maintenance, age since installation, total energy produced, operating time in each of several operating states, total distance traveled, thermal stress of each component, conditions related to geographic location, humidity, remaining grease, oil condition, turbulence intensity, air quality, wind shear, number of emergency stops, number of starts and stops, component vibrations, blade pitch activity, yaw activity, turbine design, component designs, vendor, and manufacturing location to each of the identified one or more maintenance activities for the system.

4. The method of claim 1, wherein the system comprises a wind-turbine park that is comprised of a plurality of wind-turbine generators and ancillary equipment.

5. The method of claim 1, wherein determining the value for each of the one or more associated stress factors comprises receiving information related to one of the one or more stress factors and updating the value of the one of the one or more stress factors based on the information received.

6. The method of claim 1, wherein determining the value for each of the one or more associated stress factors comprises estimating a future value for each of the one or more associated stress factors using one or more operating parameters of the system and scheduling one of the one or more maintenance activities for the system based at least in part on the estimated future value of each of the one or more stress factors associated with the one of the one or more maintenance activities.

7. The method of claim 6, wherein the system comprises a wind-turbine generator and the one or more operating parameters comprise one or more of historical, present and forecast wind and meteorological measurements, seasonality, climate, air quality, age of wind turbine generator, wind turbulence, power produced by the wind-turbine generator, period of time, information from other wind turbine generators, power factor, and trips and faults seen by the wind turbine generator.

8. The method of claim 6, wherein estimating the future value for each of the one or more associated stress factors comprises estimating the future value for each of the one or more associated stress factors based at least in part on historical values for the one or more stress factors.

9. The method of claim 1, wherein determining, using a computing device, whether to schedule one of the one or more maintenance activities for the system based on the determined value of each of the one or more stress factors associated with the one of the one or more maintenance activities further comprises allocating maintenance resources to any scheduled one or more maintenance activities.

10. The method of claim 1, wherein determining, using the computing device, whether to schedule one of the one or more maintenance activities for the system based on the determined value of each of the one or more stress factors associated with the one of the one or more maintenance activities comprises scheduling the maintenance activity before or when the determined value for at least one of the one or more associated stress factors meets or exceeds a trigger point for the at least one of the one or more associated stress factors.

11. A system comprised of:
a network interface;
a memory; and
a processor, wherein the processor is operably connected to the memory and the network interface, and the processor is configured to:
store, in the memory, one or more maintenance activities that have been identified for a mechanical system;
associate one or more stress factors to each of the identified one or more maintenance activities for the mechanical system and store the associated stress factors in the memory;
receive information related to at least one of the one or more associated stress factors and determine a value for each of the one or more associated stress factors based at least in part on the received information, wherein at least part of the received information can be received over a network via the network interface; and
determine whether to schedule one of the one or more maintenance activities for the mechanical system based on the determined value of each of the one or more stress factors associated with the one of the one or more maintenance activities.

12. The system of claim 11, wherein the mechanical system comprises a wind-turbine generator.

13. The system of claim 12, wherein the one or more stress factors comprise one or more of calendar time since the last maintenance, age since installation, total energy produced, operating time in each of several operating states, total distance traveled, thermal stress of each component, conditions related to geographic location, humidity, remaining grease, oil condition, turbulence intensity, air quality, wind shear, number of emergency stops, number of starts and stops, component vibrations, blade pitch activity, yaw activity, turbine design, component designs, vendor, and manufacturing location.

14. The system of claim 11, wherein the mechanical system comprises a wind-turbine park that is comprised of a plurality of wind-turbine generators and ancillary equipment.

15. The system of claim 11, wherein the processor configured to determine the value for each of the one or more associated stress factors comprises the processor receiving information related to one of the one or more stress factors and updating the value of the one of the one or more stress factors based on the information received.

16. The system of claim 11, wherein the processor configured to determine the value for each of the one or more associated stress factors comprises the processor configured to estimate a future value for each of the one or more associated stress factors using one or more operating parameters of the mechanical system and scheduling one of the one or more maintenance activities for the mechanical system based at least in part on the estimated future value of each of the one or more stress factors associated with the one of the one or more maintenance activities.

17. The system of claim 16, wherein the mechanical system comprises a wind-turbine generator and the one or more operating parameters comprise one or more of historical, present and forecast wind and meteorological measurements, seasonality, climate, air quality, age of wind turbine generator, wind turbulence, power produced by the wind-turbine generator, period of time, information from other wind turbine generators, power factor, and trips and faults seen by the wind turbine generator.

18. The system of claim 16, wherein the processor configured to estimate the future value for each of the one or more associated stress factors comprises the processor configured to estimate the future value for each of the one or more associated stress factors based at least in part on historical values for the one or more stress factors.

19. The system of claim 11, wherein the processor configured to determine whether to schedule one of the one or more maintenance activities for the mechanical system based on the determined value of each of the one or more stress factors associated with the one of the one or more maintenance activities further comprises the processor configured to allocate maintenance resources to any scheduled one or more maintenance activities.

20. The system of claim 11, wherein the processor configured to determine whether to schedule one of the one or more maintenance activities for the system based on the determined value of each of the one or more stress factors associated with the one of the one or more maintenance activities comprises scheduling the maintenance activity before or when the determined value for at least one of the one or more associated stress factors meets or exceeds a trigger point for the at least one of the one or more associated stress factors.

21. A computer program product comprised of computer-executable code sections contained on a non-transitory computer-readable medium, said computer-executable code sections for:
associating one or more stress factors to each of one or more maintenance activities for a system;
determining a value for each of the one or more associated one or more stress factors; and
determining whether to schedule one of the one or more maintenance activities for the system based on the determined value of each of the one or more stress factors associated with the one of the one or more maintenance activities.
